(19) United States
(12) Patent Application Publication
(10) Pub. No.: US 2010/0250419 A1
(43) Pub. Date: Sep. 30, 2010

(54) SYSTEMS AND METHODS FOR DETERMINING A TARGET BUDGET ALLOCATION

(75) Inventors: Kazi M. Ariff, Quincy, MA (US); Carol A. Smith, Edgartown, MA (US); Shane A. Johnson, Charlotte, NC (US); Russell W. Tipper, Boston, MA (US); Yicong Li, Lexington, MA (US); Sean M. O'Connor, Scituate, MA (US); Thomas D. Kelley, Hingham, MA (US); Susan S. Thomas, Gastonia, NC (US); William F. Borowski, Millbury, MA (US); William J. Aheron, Charlotte, NC (US); Judith M. Anderson, East Walpole, MA (US); Steven K. Hayes, Bemus Point, NY (US); Neal G. Wolfson, Lexington, MA (US); Jeffrey P. Judd, Boston, MA (US); James P. Kirkman, Acton, MA (US); Jeffrey H. Bierer, Charlotte, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, Charlotte, NC (US)

(21) Appl. No.: 12/414,428

(22) Filed: Mar. 30, 2009

(51) Int. Cl. G06Q 40/00

(52) U.S. Cl. 705/35

(57) ABSTRACT

Systems, methods, and computer program products are provided for a financial institution-implemented budget system that determines and/or recommends a financial institution customer's targeted budget allocation based on current budget allocation, responses to a budget profile questionnaire and/or peer budget allocation data. The budget profile questionnaire is instrumental in understating the spending needs of the customer. Peer budget allocation data takes into account the customer's profile data, such as demographics and the like and allows for the customer to select target budget allocation from amongst national averages or peers in the same residential area.

### REFERENCE TO CO-PENDING APPLICATIONS FOR PATENT

The present Application for Patent is related to the following co-pending U.S. patent applications:

“Systems and Methods for Budget Guardrails”, inventors Ariff et al., having an Attorney Docket No. 014033.000557, filed concurrently herewith, assigned to the assignee hereof, and expressly incorporated by reference herein

“Systems and Methods for Determining a Financial Health Indicator”, inventors Ariff et al., having an Attorney Docket No. 014033.000558, filed concurrently herewith, assigned to the assignee hereof, and expressly incorporated by reference herein; and

“Systems and Methods for Determining the Budget Impact of Purchases, Potential Purchases and Cost Adjustments”, inventors Ariff et al., having an Attorney Docket No. 014033.000559, filed concurrently herewith, assigned to the assignee hereof, and expressly incorporated by reference herein.

### FIELD

In general, embodiments herein disclosed relate to systems, methods, and computer program products for determining a target budget allocation and, more specifically, a financial institution-implemented system for determining target budget allocation for customers based on current budget allocation, a budget profile questionnaire and/or peer budget allocations.

### BACKGROUND

In general, most individuals have a difficult time saving money. This problem is evident in the United States where the national average personal savings rate has recently moved from the positive to the negative for the first time since the Great Depression, meaning Americans are spending more than they are saving. While statistics show that 78 million Americans will retire in the next 20 years, long-term financial planning and retirement goals for the vast majority of these individuals are cast in doubt by the inability to save.

Furthermore, problems associated with inadequate savings not only affect long-term retirement plans, but also come to the forefront during prolonged recessionary periods, such as the global recession currently being experienced. With individuals being displaced from their employment at alarming rates, these individuals need to call on their short-term savings as a means of support in the interim. In this regard, the need to address the savings problem takes on a sense of urgency.

However, admitting a savings problem and doing something about it are not one in the same. Saving money requires an individual to budget properly and, for whatever reason, be it unwillingness, inability or the like, individuals have shown a proven tendency not to budget properly. This problem is exasperated in a downturned economy in which a whole new sector of the population must accept at least a slight decrease, and in some instances a significant decrease, in their standard of living. Thus, the need to budget, and moreover budget effectively, becomes imperative.

Currently, many commercial applications exist that assist individuals with budgeting. For example, Microsoft® Money, available from Microsoft Corporation of Redmond, Wash. and Intuit® Quicken®, available from Intuit Incorporated of Mountain View, Calif. are two such commercially available budget applications. However, these applications may be limited in the data resources they have available to assess a user's current budget allocation and determine or make recommendations for a user's target budget allocation. Moreover, these applications may be limited in terms of the data resources they have available to automatically track an individual's spending, i.e., the individual's ability to stay on budget. In addition to possible data resource limitations, the corporations that provide these applications are not in the business of providing their users with financial planning and/or financial advice and, therefore, do not employ a staff dedicated to ensuring their users financial security. Therefore, when using these types of commercial budget applications, the user is on their own when it comes to making financial decisions that affect their budget, short-term savings and/or long-term savings.

Additionally, known budgeting applications do not possess the ability to ensure that users adhere to their assigned budgets. In this regard, the commercial entities that provide such applications are not in a position to reward and/or penalize users that are successful or fail to stay on budget. In addition, currently existing budgeting applications do not possess the ability to provide the user a comprehensive and dynamic financial health indicator that takes into account various factors that cumulatively affect the user's overall financial health.

In addition, current budgeting applications do not provide for a spending deterrence. In this regard, current budgeting applications do not assess the budget ramifications of proposed expenditures, recurring expenditures or cost adjustments to fixed expenditures, such as rent, house payment, automobile payment and the like.

Up until now, financial institutions have been focused on providing their customers with investment services, loan services and the like. However, by shifting the financial institution mindset from an investment strategy to a budget strategy, these institutions, such as banks and the like, can capitalize on an increase in customer assets (i.e., savings), an increase in customer retention, and lower the credit risk for their customer base. Additionally, financial institutions have the ability to leverage instrumental budget-related data that may be otherwise unavailable to other commercial entities providing budget applications.

Therefore, a need exists to develop systems, methods, apparatus, computer program products and the like for an improved budgeting system. In this regard, the budget system should improve upon the accuracy of the determination of the user's current budget allocation and provide for a more comprehensive and focused means for determining and/or recommending a target budget allocation to the user. In addition, desired systems, methods, apparatus, computer program products and the like should provide for a better means to ensure that the user stays on track in terms of their budget allocation and a means to reward and/or penalize the user if they do/do not stay on their budgeting track. Additionally, the desired systems, methods, apparatus, computer program products and the like should provide for a dynamic tool that indicates how well a user is doing in regards to meeting their budget, making improvements in savings and/or improving their overall creditworthiness. Moreover, the desired systems, methods, apparatus, computer program products and the like should provide for a spending deterrence that affectively limits the amount of spending incurred by the user, thereby further assisting the user in adhering to their respective target budget allocation.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, systems and computer program products are defined that provide for a financial institution-implemented budget system that determines and/or recommends a financial institution customer's targeted budget allocation based on current budget allocation, responses to a budget profile questionnaire and/or peer budget allocation data. The budget profile questionnaire is instrumental in understating the spending needs of the customer. Peer budget allocation data takes into account the customer's profile data, such as demographics and the like and allows for the customer to select target budget allocation from amongst national averages or peers in the same residential area.

In addition, the financial institution has access to customer data and, specifically customer portfolio data, including, but not limited to, account transaction information that indicates the type of purchases being made by the customer. In this regard, the financial institution is able to accurately determine the customer's current budget allocation and use the current budget allocation to determine a target budget allocation.

According to one embodiment of the invention, a method for determining target budget allocation for a financial institution customer is defined. The method includes determining the customer's current budget allocation, providing the customer a budget profile questionnaire that includes a plurality of budget profile questions and receiving customer responses to the plurality of budget profile questions. The method further includes determining the customer's target budget allocation based on the customer's current budget allocation and the customer responses to the plurality of budget profile questions and storing the customer's target budget allocation in a customer budget profile.

In accordance with specific embodiments of the method, one or more of the plurality of budget profile questions may relate to spending habits of the customer or may determine the latent flexibility within the customer's current budget. In addition, the method may include scoring and weighting the customer responses to the plurality of budget profile questions based on each question's significance to target budget allocation to identify the appropriate customer target budget allocation.

In accordance with further specific embodiments of the method, determining the customer's current budget allocation may include accessing current budget-related data associated with the customer from one or more of the financial institution's databases and/or one or more external databases, such as other financial institution databases or the like, and determining the customer's current budget allocation based on the accessed current budget-related data.

Still further specific embodiments of the method, determining the customer's target budget allocation may include determining one of a plurality of predetermined target budget allocation models. Each model may be based on a variance in customer demographics. Additionally, other specific embodiments of the method include receiving one or more customer modifications to the determined customer target budget allocation and storing the customer modified target budget allocation in the customer budget profile.

In accordance with further embodiments, the method may also include determining peer target budget allocation data associated with the customer and providing the peer target budget allocation data to the customer. The peer target budget allocation data may include at least one of life stage peer data, national statistic peer data, individuals residing near the customer peer data or the like. In such embodiments, the method may also include receiving customer selections for target budget allocation based on the peer target budget allocation data. The customer selections may, in some embodiments, be in lieu of providing a budget profile questionnaire to the customer and receiving customer responses to the plurality of budget profile questions in the questionnaire.

Another embodiment of the invention is provided for by an apparatus configured for determining target budget allocation for financial institution customers. The apparatus, which may include more than one device, includes a computing platform including at least one processor and a memory. The apparatus additionally includes a financial institution-implemented budget module stored in the memory, executable by the processor and operable to provide budget tracking for financial institution customers. The budget module includes a budget allocation module that includes a current budget allocation routine and a target budget allocation routine. The current budget allocation routine is operable to determine a customer's current budget allocation. According to one specific embodiment of the apparatus, the current budget allocation routine is operable to access budget-related data in one or more financial-institution databases and/or one or more external databases such as other financial institution databases, credit card company databases or the like and to determine the customer's current budget allocation based on the accessed budget-related data.

Additionally, the target budget allocation routine is operable to provide the customer a budget profile questionnaire that includes a plurality of budget profile questions and receive customer responses to the plurality of budget profile questions. The target budget allocation routine is also operable to determine the customer's target budget allocation based on the customer's current budget allocation and the customer responses to the plurality of budget profile questions and store the customer's target budget allocation in a customer budget profile.

In accordance with specific embodiments of the apparatus, the budget profile questionnaire includes one or more budget profile questions related to spending habits and/or that determine latent flexibility within the customer's current budget.

In accordance with further specific embodiments of the apparatus, the target budget allocation routine may be further operable to score and/or weight the customer responses to the plurality of budget profile questions based on each question's significance to target budget allocation to identify the appropriate target budget allocation for the customer. According to other specific embodiments of the apparatus, the target budget allocation routine may be further operable to determine one of a plurality of predetermined target budget allocation models. Each model is based on a variance in customer demographics. In still further embodiments of the apparatus, the target budget allocation routine may be further operable to receive one or more customer modifications to the determined customer target budget allocation and store the customer modified target budget allocation in the customer budget profile.

According to other specific embodiments the apparatus may include a target budget allocation recommender that is operable to determine peer target budget allocation data associated with the customer and provide the peer target budget allocation data to the customer. The peer target budget allocation data may include, but is not limited to, at least one of life stage peer data, national statistic peer data, individuals residing near the customer peer data or the like. The budget allocation recommender may be further operable to receive customer selections for target budget allocation based on the peer target budget allocation data. In certain embodiments, the customer selections of the peer recommendations are in lieu of implementing the target budget allocation module.

Yet another embodiment of the invention is defined by a computer program product that includes a computer-readable medium. The medium includes a first set of codes for causing a computer to determine the customer's current budget allocation, a second set of codes for causing a computer to provide the customer a budget profile questionnaire that includes a plurality of budget profile questions and a third set of codes for causing a computer to receive customer responses to the plurality of budget profile questions. The medium additionally includes a fourth set of codes for causing a computer to determine the customer's target budget allocation for the plurality of budget categories based on the customer's current budget allocation and the customer responses to the plurality of budget profile questions, and a fifth set of codes for causing a computer to store the customer's target budget allocation in a customer budget profile.

According to one specific embodiment of the computer program product, the second set of codes may be further operable to cause the computer to provide the budget profile questionnaire that includes one or more budget profile questions related to spending habits and/or that determine latent flexibility within the customer's current budget. According to still further embodiments, the computer program product may include a sixth set of codes for causing a computer to score and/or weight the customer responses to the plurality of budget profile questions based on each question's significance to target budget allocation prior to executing the fourth set of codes.

In other specific embodiments of the computer program product, the first set of codes may be further operable to cause the computer to access current budget-related data associated with the customer from one or more of the financial institution's databases and/or one or more external databases and determine the customer's current budget allocation based on the accessed current budget-related data.

In still further embodiments of the computer program product, the fourth set of codes may be further operable to cause the computer to determine one of a plurality of predetermined target budget allocation models. Each model is based on a variance in customer demographics. Additionally, the computer program product may include another set of codes for causing a computer to receive one or more customer modifications to the determined customer target budget allocation and storing the customer modified target budget allocation in the customer budget profile.

Yet another specific embodiment of the computer program product includes another set of codes for causing a computer to determine peer target budget allocation data associated with the customer and provide the peer target budget allocation data to the customer. The peer target budget allocation data may include, but is not limited to, at least one of life stage peer data, national statistic peer data or individuals residing near the customer peer data. Additionally, in such embodiments, the computer program product may include another set of codes for causing a computer to receive customer selections for target budget allocation based on the peer target budget allocation data. In certain embodiments, the customer selections may be in lieu of receiving customer responses to the plurality of budget profile questions and determining the customer's target budget allocation for the plurality of budget categories based on the customer responses to the plurality of budget profile questions.

Thus, methods, systems, apparatus, computer program products and the like are described in detail herein, which provide for determining and/or selecting target budget allocations for financial institution customers that utilize a corresponding financial institution-implemented budget system. According to embodiments of the invention, budget profile questioning allows the financial institution a better and improved assessment of the customer's current spending habits and the level of latent flexibility in the customer's current budget. Additionally, the financial institution is able to rely on internal databases and/or external databases to better assess the customer's current budget allocation.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram depiction of a system for budget tracking, according to an embodiment of the present invention;

FIG. 2 is a block diagram depiction illustrating an apparatus configured to provide for determination and/or selection of target budget allocation, in accordance with embodiments of the present invention;

FIG. 3 is a more detailed block diagram of an apparatus configured for providing a budget tracking system, in accordance with an embodiment of the present invention;

FIG. 4 is a flow diagram detailing a method for determination and/or selection of a target budget allocation and associated budget guardrails, in accordance with present embodiments;

FIG. 5 is a flow diagram of a method for determining a financial health indicator, in accordance with present embodiments;

FIG. 6 is a flow diagram of a method for tracking budget expenditures and, in particular tracking user-defined budget guardrails, in accordance with present embodiments;

FIG. 7 is a flow diagram of a method for determining budget impact of expenditures, in accordance with an embodiment of the present invention; and

FIG. 8 is a flow diagram of a method for targeted budget allocation, in accordance with yet another embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, methods, systems, computer programs and the like are herein disclosed that provide for a financial institution-implemented budget system that determines and/or recommends a financial institution customer's targeted budget allocation based on current budget allocation, responses to a budget profile questionnaire and/or peer budget allocation data. The budget profile questionnaire is instrumental in understating the spending needs of the customer and the latent flexibility built into the customer's current budget. Peer budget allocation data takes into account the customer's profile data, such as demographics and the like, and allows for the customer to select target budget allocation from amongst peer groups, such as national averages, peers in the same residential area or the like.

In addition, the financial institution is in the unique position of having access to customer data and, specifically customer portfolio data, including, but not limited to, account transaction information that indicates the type of purchases being made by the customer. In this regard, the financial institution is able to accurately determine the customer's current budget allocation and use the current budget allocation to determine a target budget allocation.

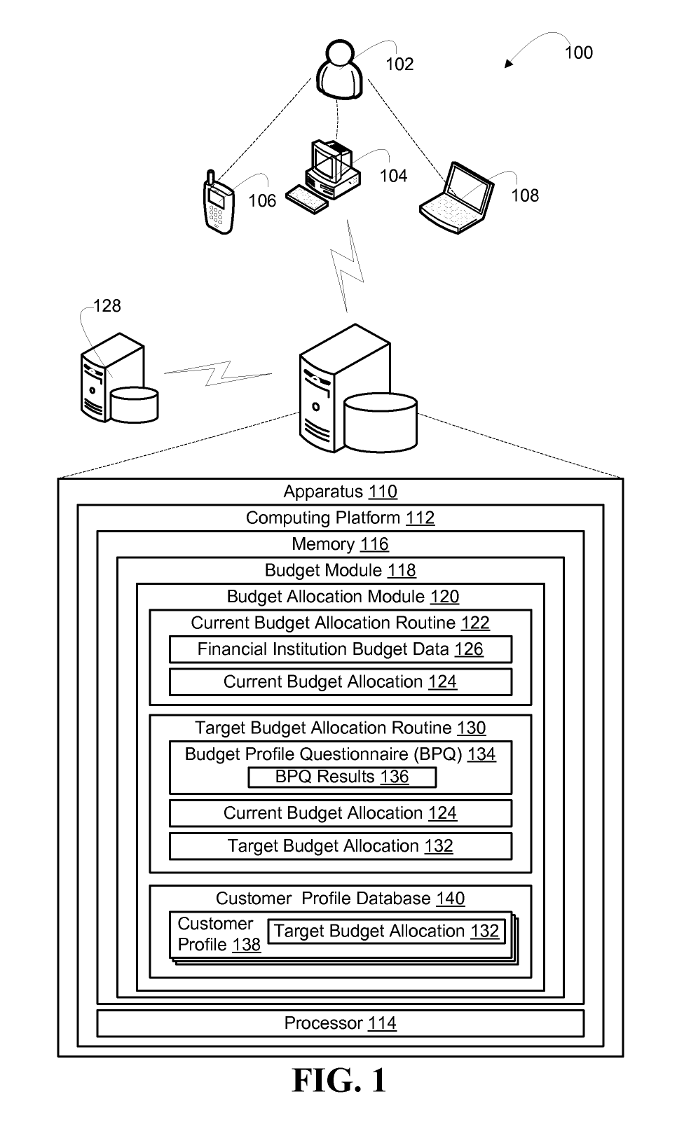

Referring to FIG. 1, a block diagram is depicted of a financial institution-implemented budget tracking system 100 that provides for a financial institution customer/user 102 to access the system wirelessly or otherwise, to track their budget from any networked device, such as a PC 104, or a portable device, such as cellular telephone 106 or laptop computer 108. In one embodiment, the budget system 100 may be a web-based system that is accessible to customers/users 102 through the financial institution's online banking site or the like.

The budget tracking system 100 also includes an apparatus 110, which may include multiple devices, for executing the budget tracking system 100 and, in particular, an apparatus configured for budget allocation determination, in accordance with an embodiment of the invention. The apparatus 110 includes a computing platform 112 having at least one processor 114 and a memory 116. The memory 116 includes a budget module 118 that is operable to implement a financial institution-based budget system that includes, but is not limited to determining or identifying target budget allocation for customers/users and subsequently tracking the budget for the customers.

According to embodiments of the presently described invention, the budget module 118 includes a budget allocation module 120 that is operable to identify and/or determine customers' target budget allocation. As such, budget allocation module 120 includes a current budget allocation routine 122 that is operable to determine the customer's/user's current budget allocation 124 upon their entry into the budget tracking system. A comprehensive and accurate depiction of the customer's current budget allocation 124 is imperative to subsequently provide for or determine an accurate target budget allocation. Merely querying the customer to provide for their current budget allocation, as is performed in many commercial budget applications, is generally insufficient because the customer may not be aware of how much they spend in any one specific budget category over a given period of time.

According to specific embodiments, the current budget allocation routine 122 may rely on internal financial institution budget-related data 126 from internal database 128 as an input for determining the current budget allocation 124. The budget-related data 126, which may include customer portfolio information, including, but not limited to, customer account transaction information, provides insight into the nature of the customer's expenditures. For example, the transaction receipt for purchases funded via a customer account, such as a debit account, checking account or the like, identify the type of product or service being purchased. The current budget allocation routine 122 may subsequently map these purchase types to a budget category, such as food, travel, entertainment or the like to determine the customer's current budget allocation.

The budget allocation module 120 also includes a target budget allocation routine 130 that is operable to determine or otherwise identify customers' target budget allocation 132 based on customer response to a Budget Profile Questionnaire (BPQ) 134, and the determined current budget allocation 124. In this regard, the BPQ 134 includes a plurality of questions that assist in identifying the customer's spending needs and wants. In particular, BPQ 134 may include questions related to the customer's current spending habits and/or questions that identify the level of latent flexibility existing in the customer's current budget. The customer responses to the BPQ 134 may be subsequently scored and weighted to provide for BPQ results 136, which are used to determine the customer's target budget allocation 132. In one specific embodiment, the determined target budget allocation may be chosen from a group of exemplary target budget allocations (not shown in FIG. 1), such that each exemplary target budget allocation is based on different customer demographics or the like.

The target budget allocation may be configured to provide for a budget percentage allocated to different budget categories. For example, 30 percent of the budget may be target allocated to rent/mortgage, 10 percent to food, 5 percent to entertainment and the like. Once the target budget allocation is determined, the customer may be afforded the ability to modify the determined target budget allocation as need be, prior to storing the target budget allocation 132 in a customer profile 138 in a budget system customer profile database 140. The customer's target budget allocation 132 is subsequently implemented by budget tracking system 100 to track the customer's progress in adhering to the target budget.

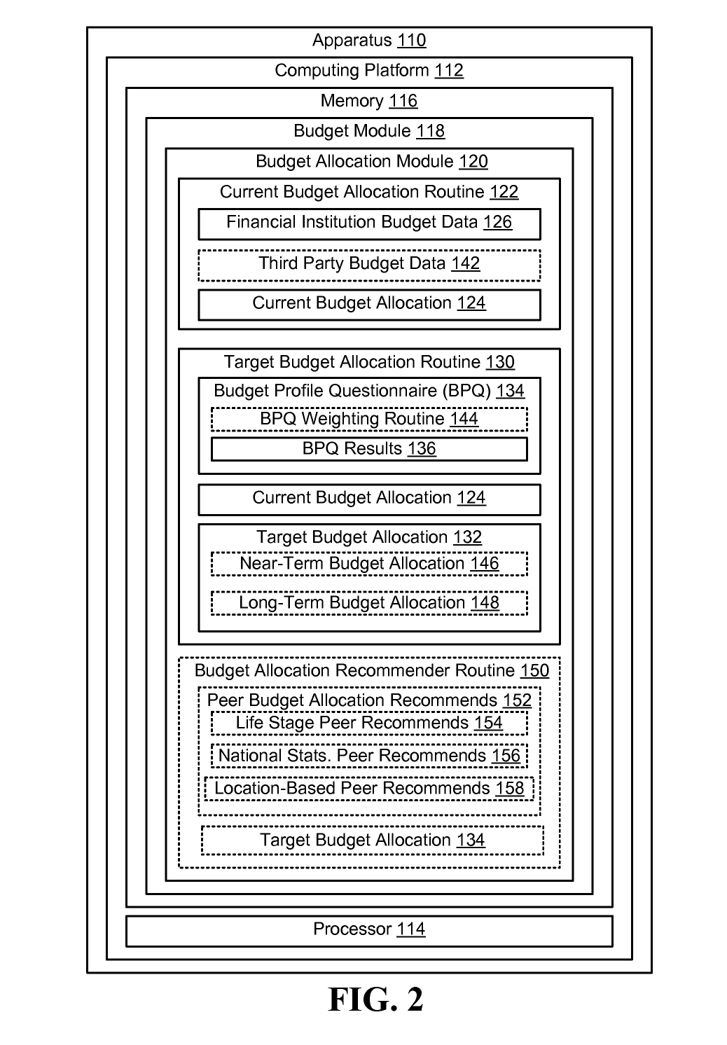

Turning the reader's attention to FIG. 2, a more detailed block diagram of apparatus 110 is depicted that highlights various optional embodiments of the budget allocation module 120. As previously noted, apparatus 110, which may comprise more than one device, includes a computing platform 112 having a memory 116 and at least one processor 114. The memory 116 stores a financial institution-implemented budget module 118 that is operable to provide a comprehensive budgeting system for financial-institution customers/users. The budget module 118 includes a budget allocation module 120 operable to determine, or otherwise identify, a target budget allocation for the users of the budget system.

Budget allocation module 120 includes current budget allocation routine 122 that is operable to determine customers' current budget allocation. As previously noted, current budget allocation routine 122 may rely on financial institution budget-related data 126 to determine the customer's current budget allocation. The financial institution budget-related data 126 may be customer portfolio data including, but not limited to, account information, such as specific account transaction data; for example, purchases or deductions from an account. Additionally, according to other alternate embodiments, the current budget allocation routine 122 may rely on third party budget-related data 142 data mined or otherwise retrieved from external databases. Examples of external databases include, but are not limited to, other financial institution databases, credit card company databases, or any other database having budget-related data that is accessible to the financial institution implementing the budget system. The third party budget-related data 142 may be implemented in conjunction with the internal financial institution budget-related data 126 instrumental to more accurately determine a customer's current budget allocation, or in certain instances, such as when the financial institution has insufficient internal data to determine the customer's current budget allocation, the third party budget-related data 142 may be the sole source of data used to determine the customer's current budget allocation.

Budget allocation module 120 additionally includes target budget allocation routine 130 that is operable to determine customers' target budget allocation 132. As previously noted, the target budget allocation routine 130 determines the target budget allocation 132 based on the customer's current budget allocation 124 and the customer's response to the Budget Profile Questionnaire (BPQ) 134. In order to properly assess the customer's response to the BPQ 134, the BPQ may implement a BPQ weighting routine 144 that weights and scores the customer's responses to the BPQ question in order to identify the appropriate target budget allocation. The weighted and scored results of the BPQ weighting routine 144 provide for BPQ results 136.

According to specific embodiments, the target budget allocation 132 may have a near-term budget allocation 146 and/or a long-term budget allocation 148. For example, the near-term budget allocation 146 may account for a daily, weekly, bi-weekly or monthly budget allocation, while the long-term budget allocation 148 may account for yearly or a greater period of time budget allocation. In this regard, near-term budget allocation 146 may account for certain period-related expenditures, such as seasonal expenditures. For example, if the customer resides in a cold weather climate, the utilities allocation may be higher in the cold weather months than in the warm weather months, allowing for modification in the allocation for other budgeted categories. However, the year-to-year budget allocation for utilities may remain the same.

The budget allocation module 120 may additionally include a target budget allocation recommender routine 150 that is operable to recommend a target budget allocation to the customer/user based on peer data. The target budget allocation recommendations that result may be used by the customer/user in lieu of the BPQ 134 and the target budget allocation routine 130 or in addition to the BPQ 134 and the target budget allocation routine 130. For example, if the customer/user does not prefer the target budget allocation rendered by the target budget allocation routine 130, the customer may choose to implement the target budget allocation recommender routine 150. The target budget allocation recommender routine 150 is operable to determine peer budget allocation recommendations for the customer/user based on the customer's/user's profile data and peer data accessible to the financial institution implementing the budget system 100. The peer data may be drawn from internal financial institution databases or may be data mined from external databases/resources. In the illustrated example of FIG. 2, the peer budget allocation recommendations 152 may include, but are not limited to, life stage peer recommendations 154, such as individuals of similar age or proximity to retirement, national statistical peer recommendations 156, or location-based peer recommendations 158, such as individuals living within the same zip code or area code as the customer/user. Based on the peer recommendations, the customer/user may choose to incorporate the peer recommendation in total or, similar to the determined target budget allocation, modify the peer recommendations to select the target budget allocation best suited for the needs. Once the customer/user has acquiesced or otherwise modified the target budget allocation to their liking, the target budget allocation is stored in the customer profile 138 of customer profile database 140 (as shown in FIG. 1).

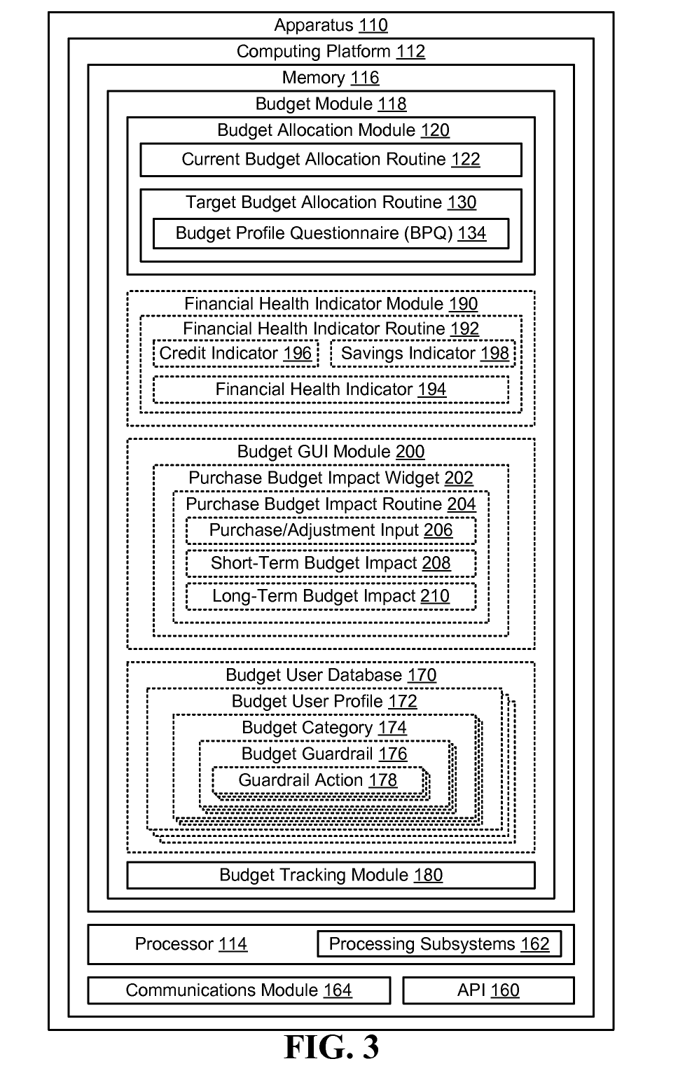

Referring to FIG. 3, a more detailed block diagram is depicted of apparatus 110 that highlights various additional aspects of the budget system 100 herein disclosed. The apparatus 110 may include any type of one or more computerized, communication devices, such as a server, a personal computer, a portable computer, or any device or devices that include a computing platform and have a wired and/or wireless connection to a network or the Internet.

The apparatus 110 includes computing platform 112 that can transmit data across a network, and that can receive and execute routines and applications. Computing platform 112 includes memory 116, which may comprise volatile and non-volatile memory such as read-only and/or random-access memory (RAM and ROM), EPROM, EEPROM, flash cards, or any memory common to computing platforms. Further, memory 116 may include one or more flash memory cells, or may be any secondary or tertiary storage device, such as magnetic media, optical media, tape, or soft or hard disk.

Further, computing platform 112 also includes processor 114, which may be an application-specific integrated circuit (“ASIC”), or other chipset, processor, logic circuit, or other data processing device. Processor 114 or other processor such as ASIC may execute an application programming interface (“API”) 160 that interfaces with any resident programs, such as budget module 118 stored in the memory 116 of the apparatus 110.

Processor 114 includes various processing subsystems 162 embodied in hardware, firmware, software, and combinations thereof, that enable the functionality of apparatus 110 and the operability of the apparatus 110 on a network. For example, processing subsystems 162 allow for initiating and maintaining communications, and exchanging data, with other networked devices. For the disclosed embodiments, processing subsystems 162 of processor 114 may include any subsystem used in conjunction with budget module 118.

Computing platform 112 additionally includes communications module 164 embodied in hardware, firmware, software, and combinations thereof, that enables communications among the various components of the apparatus 110, as well as between the apparatus 110 and an external network, such as the Internet or the like. In described embodiments, the communication module 164 enables the communication of all correspondence between apparatus 110 and other computing devices, such as customer/user devices, 104, 106 and 108 (shown in FIG. 1).

As previously noted and discussed, the memory 116 of computing platform 112 includes budget allocation module 120 that is operable to provide for determining a target budget allocation for a financial institution customer based on current budget allocation and customer/user responses to a budget profile questionnaire (BPQ) or allowing a customer/user to select a target budget based on peer data recommendations. As such, budget allocation module 120 includes a current budget allocation routine 122 operable to provide for the customer's/user's current budget allocation and a target budget allocation routine 130 that is operable to provide for the target budget allocation based on the current budget allocation and customer/user responses to BPQ 134.

Optional embodiments of the apparatus may provide for the budget module 118 to include customer/user-defined budget guardrails and actions associated with the defined guardrail. In this regard, budget user database 170 may store a plurality of budget user profiles 172. Each budget user profile 172 may define a plurality of user-defined or budget system-defined budget categories 174, such as housing, food, entertainment, transportation and the like. Each budget category 174 may provide for one or more user-defined budget guardrails 176 and each guardrail will have one or more related guardrail actions 178. A guardrail is a customer/user defined spending limit that upon either being met or proximate to being met, depending on system or user configuration, prompts the occurrence of the customer/user defined guardrail action. As such, budget tracking module 180 is operable to track the expenditures made by the customer/user and initiate the defined guardrail action if a customer's/user's pre-defined guardrail spending limit has been met or is proximate to being met.

According to one embodiment, the customer/user may define a budget guardrail 176 at the target budget allocation limit for a predefined category, or at any desired spending limit at or above the target budget allocation for a given category.

In one embodiment of the invention, the customer/user defined action may be a guardrail alert that is communicated to the customer to inform them that they have met a guardrail limit or are proximate to a guardrail limit. According to one embodiment, the customer/user may configure the communication mechanism used to communicate the alert, such as an email, a SMS/text message, voice mail or the like. Additionally, according to another embodiment, the customer/user may configure the frequency at which the alerts are communicated to the customer/user. For example, alerts may be communicated more frequently the closer the customer/user gets to a guardrail, or the closer the customer/user gets to a target budget allocation category limit.

In another embodiment of the invention, the customer/user defined action may be a guardrail penalty that is enforced against the customer/user if the customer/user exceeds the spending limit of a guardrail. Since the guardrail actions are generally customer defined, the associated guardrail penalties are self-imposed penalties. A guardrail penalty may include, but is not limited to, forbidding further electronic purchases in the associated budget category until a new budget period starts. In this regard, credit or debit purchases may be denied for products/services associated with the budget category. Additionally, a guardrail penalty may include, but is not limited to, an automatic designation of funds to a restricted savings account, an automatic transfer designation of funds to a charitable organization or the like.

Other embodiments of the budget module 118 may provide for a financial health indicator module 190 that is operable to dynamically determine and provide to the customer/user an indicator of a customer's/user's financial health. In this regard, the financial health indicator module 190 may include a financial health indicator routine 192 that is operable to determine a financial health indicator 194 of the customer's/user's financial health based on a credit indicator 196 and a budget indicator 198. The credit indicator 196 may be one or more credit scores as provided by a credit reporting bureau. A financial institution implementing the budget system of the present invention generally has access to a customer's credit score(s). According to one embodiment, the financial health indicator routine 192 may dynamically track the customer's/user's credit scores to provide for a credit indicator/score. The budget indicator 198 may be determined based on budget tracking accomplished via budget tracking module 180. By constantly tracking a budget indicator 198 and a credit indicator 196, the resulting financial health indicator 194 is a dynamic indicator that accurately reflects the financial health of the customer/user at any point in time. The financial health indicator 194 may be in a form that indicates the customer's/user's financial health, such as, but not limited to, a numerical score, an alphabetic grade, a color on a color scale or the like.

The financial health indicator 194 may be communicated or otherwise provided to the customer/user based on budget system configuration and/or customer/user configuration. In one embodiment, the financial health indicator 194 may be provided as a widget running on a dashboard-type application, such that the financial health indicator 194 is dynamically accessible to the customer/user from any networked device, such as a personal computer, laptop computer or a hand-held device, such as a cellular telephone device or the like.

According to still further embodiments, the budget module 118 may include a budget Graphical User Interface (GUI) module 200 operable to provide the customer/user a displayable interface communicated via a network and operable for receiving and inputting budget tracking related information. The budget GUI module 200 may include a purchase budget impact widget 202 that is operable to provide for determination of the budget impact of an actual purchase, considered purchase, an adjustment to an ongoing purchase. The widget may be displayed to the user via a dashboard-type application that provides for various other budget-related tools, modules, widgets and the like.

Thus, purchase budget impact widget 202 may include purchase budget impact routine 204 that is operable to determine the budget impact of a purchase, considered purchase or an adjustment to an ongoing purchase, rental, etc. Thus the purchase budget impact widget 202 may include a purchase/adjustment input 206 operable to receive a customer/user input of a purchase amount, considered purchase amount, or adjustment amount. Thus, if the widget is accessible to the user via a hand-held device, such as a cellular telephone or the like, the user can engage the purchase budget impact widget 202 and input an amount at any point in time, such as just prior to making a purchase to determine the budget impact of the purchase. As such, the budget impact determiner aspect of the invention provides for the customer/user to make informed purchasing decisions and hopefully limits the amount of impulsive purchases.

The purchase budget impact routine 204 may be configured to determine a short-term budget impact 208 and/or a long-term budget impact 210 for the inputted amount. A short-term budget impact 208 may be, for example, a month, a portion of a month, a portion of a year, or the like. The long-term budget impact 210 may be, for example, periods greater than a year or the like. In alternate embodiments of the invention, the purchase budget impact widget 202 may include logic (not shown in FIG. 3) operable to determine recurring purchases for the customer/user and to automatically activate the widget and provide the customer/user with the budget impact for the recurring purchases, for example, if the customer/user was to forego or limit the number of recurring purchases. In one example, the logic would determine that the customer/user makes a daily or frequent purchase of coffee at a particular coffee shop, based on the identification of this recurring purchase, the widget may be automatically activated and presented to the customer/user to display the short-term and/or long-term budget impact of foregoing the recurring purchase or otherwise limiting the number of the recurring purchases.

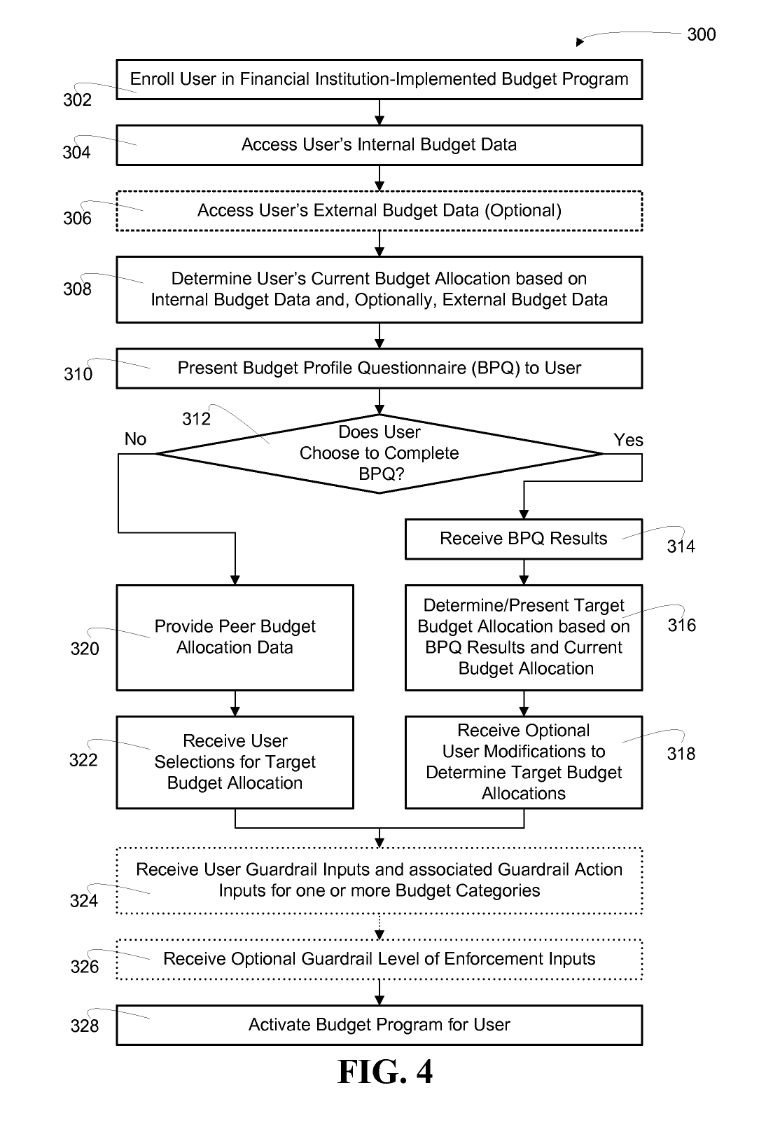

Referring to FIG. 4, a flow diagram is presented of a method 300 for determining a customer's/user's target budget allocation and defining guardrails, in accordance with present embodiments of the invention. At Event 302 the customer/user enrolls in financial institution-implemented budget program. In most instances, the customer/user may be a pre-existing financial institution customer, and, in some embodiments, being a financial institution customer may be a pre-requisite to being afforded enrollment in the budget program. According to embodiments of the invention, enrollment, configuration of the customer/user budget criteria and budget tracking information may be provided to the customer/user via a network interface, such as an online website or the like. In one specific embodiment, the configuration of the customer/user budget criteria and/or budget tracking information may be accessible online via the financial institution's online banking site.

At Event 304, once the customer/user has enrolled in the budget system, the budget system accesses internal financial institution databases, such as customer portfolio databases, to retrieve budget-related information from the customer's/user's portfolio, such as account information and the like. The budget-related information may include customer transaction data, such as transaction receipts for electronic purchases, such as debit or credit purchases.

At optional Event 306, the budget system may access external databases, such as other financial institution databases, credit card company databases or the like, in an attempt to retrieve other budget-related information associated with the customer/user. By accessing, retrieving and subsequently using external data to determine the current budget information, the current budget allocations are generally more accurate and robust. Additionally, external data may be necessary in instances in which the customer is a new customer, or in instances in which the internal database information is not sufficient to provide an accurate depiction of the customer's/user's current budget allocation.

At Event 308, the customer's/user's current budget allocation is determined based on the internal financial institution budget-related data and, optionally, the external budget-related data. The current budget allocation breaks down current expenditures on a per category basis: for example, 30% housing, 10% fuel, 5% entertainment, 15% savings and the like.

At Event 310, the customer is presented with a Budget Profile Questionnaire (BPQ) that includes a plurality of budget-related questions. Specifically, one or more questions are related to the customer's current spending habits and one or more questions are related to determining the latent flexibility in the customer's current budget. At Decision 312, a determination is made as to whether the customer/user chooses to complete the BPQ.

If the customer/user chooses to complete the BPQ, at Event 314, BPQ results are received. The results may be weighted based on budget significance and subsequently scored to result in a BPQ score. At Event 316, a target budget allocation is determined based on the BPQ results or BPQ score and the current budget allocation and subsequently presented to the customer/user. Similar to the current budget allocation, the target budget allocation breaks down target expenditures on a per category basis. At Event 318, the customer/user may modify the determined target budget allocations to meet their perceived needs.

If the customer/user chooses not to complete the BPQ, at Event 320, peer budget allocation is presented to the user as a guideline for selecting target budget allocation. The peer data may reflect national averages having or not having similar demographics as the customer/user, financial institution customers having or not having similar demographics as the user, individuals residing proximate the customer/user or the like. At Event 322, customer/user budget allocation selections are received by the customer/user, which serve to define the customer's/user's target budget allocation.

At optional Event 324, user guardrail inputs and associated guardrail action inputs are received for one or more of the categories in the target budget allocation. As previously noted, the guardrail defines an expenditure limit at which the associated guardrail action may occur. In accordance with embodiments of the invention, the guardrail may be set at, below or above the target budget allocation for the category. The guardrail action may include, but is not limited to, a guardrail alert and/or a guardrail penalty or the like.

At optional Event 326, one or more user configurable guardrail parameters are received. The guardrail parameters may affect the guardrail limit and/or the guardrail action. For example, the guardrail may define a parameter that defines when the associated action should occur, for example, when the guardrail is met/exceeded or when expenditures are within a predetermined guardrail range. The guardrail action parameters are generally guardrail action specific. For example, if the guardrail action is a guardrail alert, a guardrail parameter may further define a customer/user chosen communication mechanism, and/or a guardrail parameter may define a customer/user selected frequency for communicating the alert once the guardrail has been met, or once the expenditures are within the predetermined guardrail range. If the guardrail action is a guardrail penalty, the guardrail parameter may define the type and/or amount of the penalty. For example, the guardrail penalty may be a contribution to a specified customer account or a contribution to a designated charity. Alternatively, the guardrail penalty may define further spending limitations for the category of interest, or a spending prohibition for the category of interest.

At Event 328, once the target budget has been determined or selected and any optional guardrails are set, the budget program is activated for the customer/user and begins tracking expenditures as they pertain to the target budget allocations, tracking expenditures as they pertain to the guardrails and initiating the guardrail action if a guardrail is met, or if expenditures are within the predefined guardrail range.

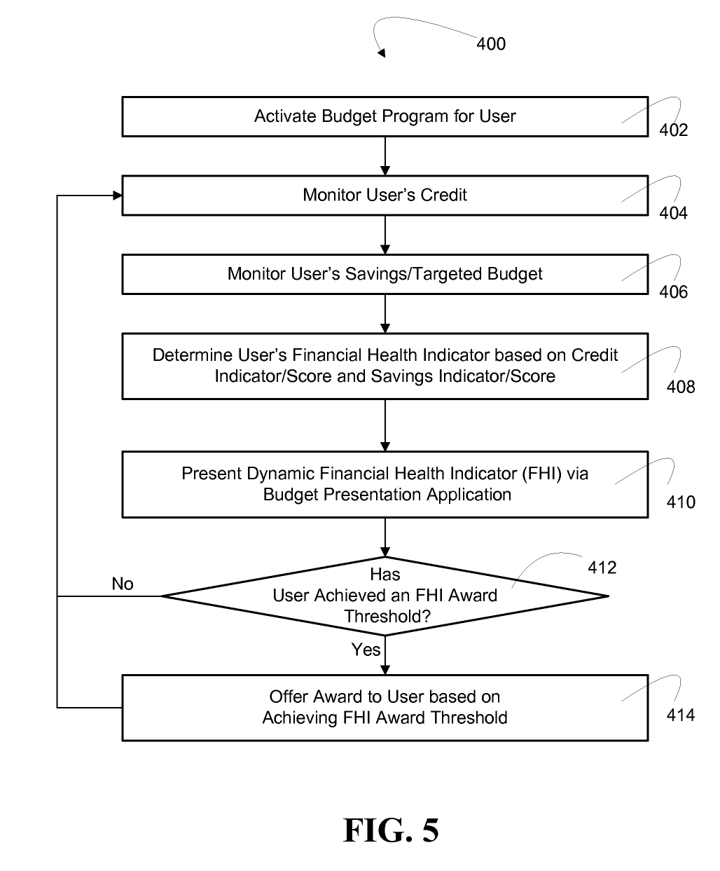

Turning the reader's attention to FIG. 5, a method 400 is detailed for determining a financial health indicator for a user of an associated budget system, in accordance with an embodiment of the present invention. At Event 402, the budget system is activated for a user. Activation is typically preceded by determining or selecting a target budget allocation and, optionally, defining guardrails and associated guardrail actions for one or more target budget allocation categories.

At Event 404, the user's credit is dynamically monitored or otherwise tracked. Credit monitoring may include monitoring a user's credit score as provided by one or more credit reporting bureaus. In one embodiment of the invention a plurality of user credit scores are monitored from different credit reporting bureaus, subsequently weighted to allow for a difference in the score and averaged to determine a collective credit score for the budget user.

At Event 406, the user's savings (i.e., the user's ability to stay on budget) is dynamically monitored or otherwise tracked. The user's savings indicator may be based on short-term savings or long-term savings or any combination of both. The savings indicator may provide for an overall savings score or the like.

At Event 408, a financial health indicator is determined for the user based on the credit indicator/score and the savings indicator/score. It should be noted that the financial health indicator may be based on factors other than the credit indicator/score and the savings indicator/score. In one specific embodiment, the financial health indicator is based on a ratio of about 70% credit indicator/score and about 30% savings indicator/score. The financial health indicator may be a numeric score, an alphabetic grade, a color on a color scale or the like.

At Event 410, the dynamic financial health indicator is presented to the user via a budget presentation (i.e., Graphical User Interface (GUI)) application. According to one embodiment, the financial health indicator may be presented to the user online via a budget system portal or the like. In other embodiments, the financial health indicator may be provided via a widget that runs on a dashboard-type budget application, As such, the financial health indicator may be provided to the user via any wired and/or wireless networked device, including, but not limited to, a PC, a laptop, a hand-held device, such as a cellular telephone or the like. The dynamic nature of the financial health indicator means that the indicator may fluctuate in real-time or near-real-time based on current expenditures made by the user.

At optional Decision 412, if the financial health indicator is associated with a rewards program, a determination may be continually made to determine if the user's financial health indicator has risen to a level (i.e., met a threshold or sustained a threshold for a predetermined period of time) to warrant a reward. Rewards may include, but are not limited to, better rates of return on a financial institution account, better pricing on financial institution services and/or products, a reward gift or the like. If a determination is made that the financial health indicator has risen to a reward level, at Event 414, the reward is automatically provided to or offered to the user or a determination is automatically triggered to determine if the user otherwise qualifies for the designated reward. If a determination is made that the financial health indicator has not risen to the reward level, the process returns to Event 404 for further tracking of the credit indicator/score and savings indicator/score and dynamic determination of the financial health indicator based on the tracked credit indicator/score and savings indicator/score.

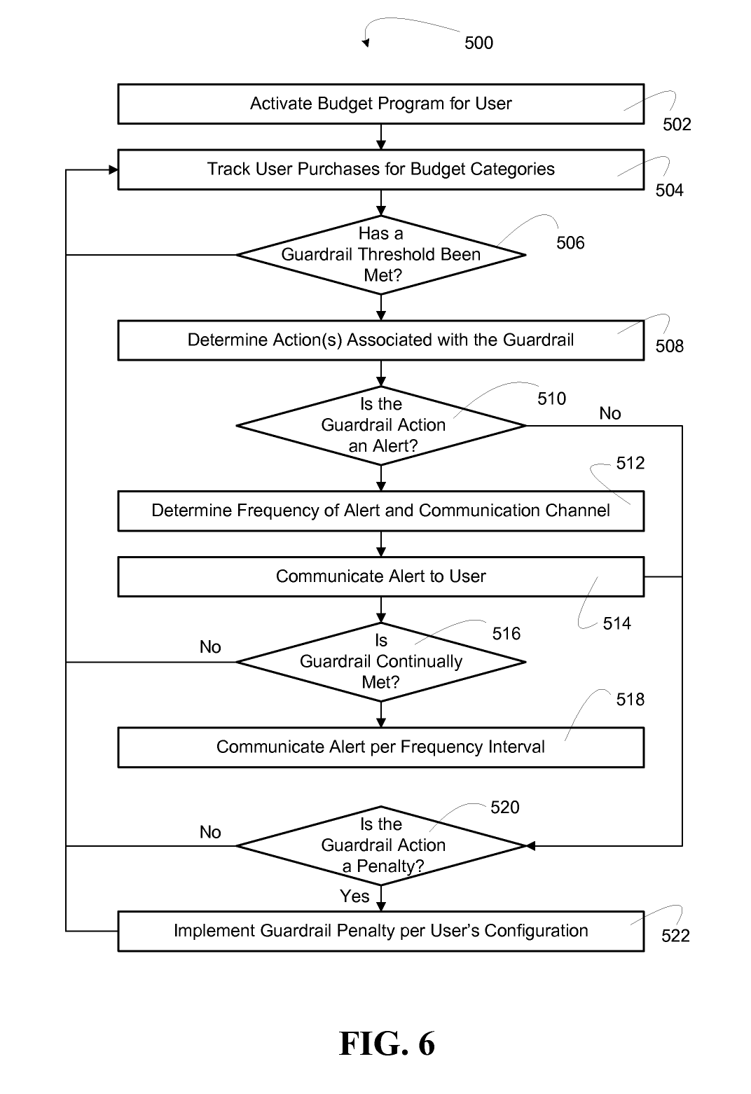

Referring to FIG. 6, a method 500 is provided for tracking guardrails and implementing the action associated with a guardrail in the event the guardrail is achieved, in accordance with embodiments of the present invention. At Event 502, the budget tracking program is activated for a specified user. As described in the flow diagram of FIG. 4, activation of the user is preceded by determination and/or selection of a target budget allocation and selection of guardrails and actions associated with the guardrails. At Event 504, the user's purchases and/or expenditures are tracked for budgeting purposes and applied to the plurality of budget categories.

At Decision 506, a determination is made as to whether a guardrail has been achieved or, if so configured, whether expenditures are within a specified predetermined range of a guardrail that prompts a guardrail action. If the guardrail has not been achieved or otherwise met, the flow returns to Event 502 for further tracking of user's purchases and expenditures. If a guardrail has been determined to be met, then at Event 508, the action or actions associated with the guardrail are determined.

At Decision 510, a determination is made as to whether the guardrail action is an alert. If the guardrail action is determined to be an alert, then at Event 512, the frequency of the alert is determined and the communication channel for the alert is determined. The frequency of the alert and/or the communication channel for the alert may be user-configured or configured within the budget system. Frequency of the alert pertains to how frequently the alert will be communicated to the user during the current budget period, for example, during the current month, once the guardrail has been achieved, or once expenditures are within the predetermined range for prompting guardrail action. The communication channel may be an online communication, email communication, SMS/text communication, voice mail communication or the like. In one embodiment of the invention, the user may configure the budget system to communicate the alert via more than one communication channel. At Event 514, the alert is communicated to the user via the designated communication channel.

At Decision 516, a determination is made as to whether the guardrail threshold is continually being achieved. In some instances, it may be possible to achieve a guardrail for a specified budget period and subsequently fall below the guardrail, for example, if negative expenditures occur in the category in which the guardrail was achieved. If the guardrail is no longer being achieved, then the flow returns to Event 504 for further tracking of user expenditures. If the guardrail continues to be achieved (i.e., the guardrail threshold is met), then at Event 518, the alert is communicated to the user at the predefined frequency interval.

If a determination is made that the guardrail action is or is not an alert, at Decision 520, a determination is made as to whether the guardrail action is a penalty. It should be noted that while the flow diagram of FIG. 6 is limited to guardrail actions being alerts and/or penalties, it is possible and within the confines of the present invention for the guardrail action to be any other action aside from an alert or penalty. As previously noted the penalty may come in the form of a contribution to a user's financial institution account, such as a savings account, an IRA or the like, a contribution to a designated charity, or a prohibition or limitation of further spending in the category associated with the guardrail. If the guardrail action is determined to be a penalty, then at Event 522, the penalty is implemented per the user's configuration as to the type of penalty and the amount or severity of the penalty. If the guardrail action is determined to not be a penalty, the flow returns to Event 504 for further tracking of the user's expenditures.

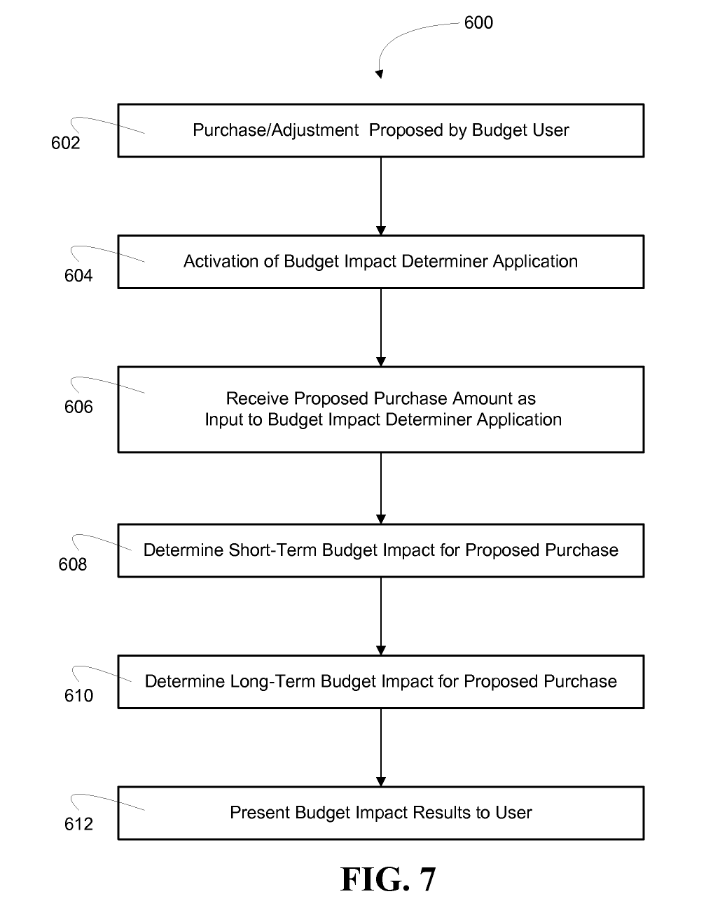

Referring to FIG. 7, a flow diagram is depicted of a method 600 for budget impact determination, in accordance with an embodiment of the present invention. At Event 602, the budget system user is presented with a proposed expenditure or an adjustment to a pre-existing expenditure, such as a change in a mortgage payment or the like. At Event 604, based on the proposed expenditure, the user activates a budget impact determiner application. It should be noted that while the illustrated flow requires an expenditure or expenditure adjustment to be proposed or otherwise contemplated by the budget user, in practice and within the context of the invention, the budget impact determiner application can be accessed at any point in time by the user, prior to an expenditure or after an expenditure has been undertaken. In one embodiment of the invention, the budget impact determiner application is accessible via the user's hand-held device, such as a cellular telephone; as such, the user may access the application at a point-of-sale, such as a retail outlet, prior to making a purchase to assess the budgetary impact of the purchase.

At Event 606, the proposed expenditure amount or expenditure adjustment is inputted into the budget impact determiner application. It should be noted that one alternate embodiment of the application provides for the application to logically determine recurring expenditures, which, once determined, provide for the automatic launch of the budget impact determiner application and the automatic input of the recurring expenditure amount, such that the application automatically determines the budget impact of the recurring purchase and presents the results to the user.

At Event 608, the application determines the short-term budget impact of the expenditure. The short-term budget impact may be any short-term period as defined by the user or the system. For example, the short-term period may be a month, a portion of the month, a year or a portion of the year. At Event 610, the application determines the long-term budget impact of the expenditure. The long-term budget impact may be any long-term period as defined by the user or the system. For example, the long-term period may be a year, or any period greater than a year. At Event 612, the results of the budget impact determination are presented to the user or otherwise communicated to the user.

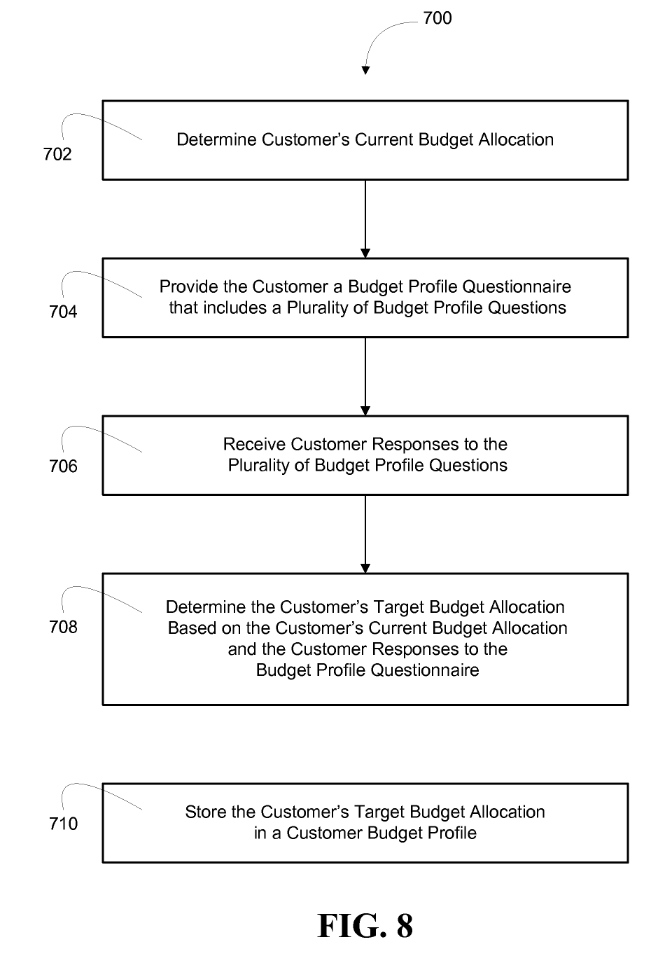

Referring to FIG. 8, a flow diagram is provided of a method 700 for determining target budget allocation in a financial institution-implemented budget system, in accordance with an embodiment of the present invention. At Event 702, a customer's current budget allocation is determined. According to one embodiment of the invention, the current budget allocation is determined based on a customer's/user's internal financial institution budget-related data, such as transaction data or the like. In optional embodiments, the current budget allocation may also be determined based on data mined from external sources, such as other financial institutions, credit card companies and the like.

At Event 704, the customer is provided a Budget Profile Questionnaire (BPQ) that includes a plurality of budget profile questions. According to specific embodiments, one or more of the budget profile questions may be related to current spending habits and/or the latent flexibility in the customer's/user's current budget. At Event 706, customer responses to the plurality of budget profile questions are received. According to specific embodiments, the customer responses may subsequently be weighed based on budget significance and the like, and an overall budget score rendered from the weighted responses.

At Event 708, the customer's target budget allocation is determined based on the customer's current budget allocation and the customer responses to the BPQ. The target budget allocation may include multiple budget categories with a portion of the overall budget, typically defined in terms of a percentage, assigned to each category. In accordance with specific embodiments, once the target budget allocation is presented to the customer, the customer may modify the determined target budget allocation to meet the customer's budget needs. At Event 710, the target budget allocation is stored in the customer's budget profile and subsequently relied on as the basis for tracking the customer's budget.

Thus, methods, systems, computer program products and the like provide for a financial institution-implemented budget system that determines and/or recommends a financial institution customer's targeted budget allocation based on current budget allocation, responses to a budget profile questionnaire and/or peer budget allocation data. The budget profile questionnaire is instrumental in understating the spending needs of the customer. Peer budget allocation data takes into account the customer's profile data, such as demographics and the like and allows for the customer to select target budget allocation from amongst national averages or peers in the same residential area.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for determining target budget allocation for a financial institution customer, the method comprising:
determining the customer's current budget allocation;
providing the customer a budget profile questionnaire that includes a plurality of budget profile questions;
receiving customer responses to the plurality of budget profile questions;
determining the customer's target budget allocation based on the customer's current budget allocation and the customer responses to the plurality of budget profile questions; and
storing the customer's target budget allocation in a customer budget profile.

2. The method of claim 1, wherein providing the customer the budget profile questionnaire further comprises providing the budget profile questionnaire that includes one or more budget profile questions related to spending habits.

3. The method of claim 1, wherein providing the customer the budget profile questionnaire further comprises providing the budget profile questionnaire that includes one or more budget profile questions that determine latent flexibility within the customer's current budget.

4. The method of claim 1, wherein determining the customer's current budget allocation further comprises accessing current budget-related data associated with the customer from one or more of the financial institution's databases and determining the customer's current budget allocation based on the accessed current budget-related data.

5. The method of claim 1, wherein determining the customer's current budget allocation further comprises accessing current budget-related data associated with the customer from the one or more external databases and determining the customer's current budget allocation based on the accessed current budget-related data.

6. The method of claim 1, wherein determining the customer's current budget allocation further comprises accessing current budget-related data associated with the customer from one or more of the financial institution's databases and one or more external databases and determining the customer's current budget allocation based on the accessed current budget-related data.

7. The method of claim 1, further comprising weighting the customer responses to the plurality of budget profile questions based on each question's significance to the target budget allocation.

8. The method of claim 1, wherein determining the customer's target budget allocation further comprises determining one of a plurality of predetermined target budget allocation models, wherein each model is based on variance in customer demographics.

9. The method of claim 1, further comprising receiving one or more customer modifications to the determined customer target budget allocation and storing the customer modified target budget allocation in the customer budget profile.

10. The method of claim 1, further comprising determining peer target budget allocation data associated with the customer and providing the peer target budget allocation data to the customer.

11. The method of claim 10, further comprising receiving customer selections for target budget allocation based on the peer target budget allocation data, wherein the customer selections are in lieu of receiving customer responses to the plurality of budget profile questions and determining the customer's target budget allocation for the plurality of budget categories based on the customer's responses to the plurality of budget profile questions.

12. The method of claim 10, wherein determining peer target budget allocation data further comprises determining peer target budget allocation data, wherein the peer target budget allocation data includes at least one of life stage peer data, national statistical peer data or financial institution customers residing near the customer peer data.

13. An apparatus for determining target budget allocation, the apparatus comprising:
a computing platform including at least one processor and a memory; and
a financial institution-implemented budget module stored in the memory, executable by the processor and operable to provide budget tracking for financial institution customers, wherein the budget module comprises a budget allocation module that includes:
a current budget allocation routine operable to determine the customer's current budget allocation, and
a target budget allocation routine operable to provide the customer a budget profile questionnaire that includes a plurality of budget profile questions, receive customer responses to the plurality of budget profile questions, determine the customer's target budget allocation based on the customer's current budget allocation and the customer's responses to the plurality of budget profile questions, and store the customer's target budget allocation in a customer budget profile.

14. The apparatus of claim 13, wherein the budget profile questionnaire further comprises the budget profile questionnaire that includes one or more budget profile questions related to the customer's spending habits.

15. The apparatus of claim 13, wherein the budget profile questionnaire further comprises the budget profile questionnaire that includes one or more budget profile questions that determine latent flexibility within the customer's current budget.

16. The apparatus of claim 13, wherein the current budget allocation routine is further operable to access current budget-related data associated with the customer from one or more of the financial institution's databases and to determine the customer's current budget allocation based on the accessed current budget-related data.

17. The apparatus of claim 13, wherein the current budget allocation routine is further operable to access current budget-related data associated with the customer from the one or more external databases and to determine the customer's current budget allocation based on the accessed current budget-related data.

18. The apparatus of claim 13, wherein the current budget allocation routine is further operable to access current budget-related data associated with the customer from one or more of the financial institution's databases and the one or more external databases and to determine the customer's current budget allocation based on the accessed current budget-related data.

19. The apparatus of claim 13, wherein the target budget allocation routine is further operable to weight the customer's responses to the plurality of budget profile questions based on each question's significance to the target budget allocation.

20. The apparatus of claim 13, wherein the target budget allocation routine is further operable to determine one of a plurality of predetermined target budget allocation models wherein each model is based on variance in customer demographics.

21. The apparatus of claim 13, wherein the target budget allocation routine is further operable to receive one or more customer modifications to the determined customer target budget allocation and store the customer modified target budget allocation in the customer budget profile.

22. The apparatus of claim 13, wherein the budget allocation module further comprises a target budget allocation recommender that is operable to determine peer target budget allocation data associated with the customer and provide the peer target budget allocation data to the customer.

23. The apparatus of claim 22, wherein the budget allocation recommender is further operable to receive customer selections for target budget allocation based on the peer target budget allocation data, wherein the customer selections are in lieu of implementing the target budget allocation module.

24. The method of claim 22, wherein the target budget allocation recommender is further operable to determine peer target budget allocation, wherein the peer target budget allocation data includes at least one of life stage peer data, national statistical peer data or financial institution customers residing near the customer peer data.

25. A computer program product comprising:
a computer-readable medium comprising:
a first set of codes for causing a computer to determine the customer's current budget allocation;
a second set of codes for causing a computer to provide the customer a budget profile questionnaire that includes a plurality of budget profile questions;
a third set of codes for causing a computer to receive customer responses to the plurality of budget profile questions;
a fourth set of codes for causing a computer to determining the customer's target budget allocation for the plurality of budget categories based on the customer's current budget allocation and the customer responses to the plurality of budget profile questions; and
a fifth set of codes for causing a computer to store the customer's target budget allocation in a customer budget profile.

26. The computer program product of claim 25, wherein the second set of codes is further operable to cause the computer to provide the budget profile questionnaire that includes one or more budget profile questions related to the customer's spending habits.

27. The computer program product of claim 25, wherein the second set of codes is further operable to cause the computer to provide the budget profile questionnaire that includes one or more budget profile questions that determine latent flexibility within the customer's current budget.

28. The computer program product of claim 25, wherein the first set of codes is further operable to cause the computer to access current budget-related data associated with the customer from one or more of the financial institution's databases and determine the customer's current budget allocation based on the accessed current budget-related data.

29. The computer program product of claim 25, wherein the first set of codes is further operable to cause the computer to access current budget-related data associated with the customer from the one or more external databases and determine the customer's current budget allocation based on the accessed current budget-related data.

30. The computer program product of claim 25, wherein the first set of codes is further operable to cause the computer to access current budget-related data associated with the customer from one or more of the financial institution's databases and one or more external databases and determine the customer's current budget allocation based on the accessed current budget-related data.

31. The computer program product of claim 25, further comprising a sixth set of codes for causing a computer to weight the customer's responses to the plurality of budget profile questions based on each question's significance to the target budget allocation prior to executing the fourth set of codes.

32. The computer program product of claim 25, wherein the fourth set of codes is further operable to cause the computer to determine one of a plurality of predetermined target budget allocation models, wherein each model is based on variance in customer demographics.

33. The computer program product of claim 25, further comprising a sixth set of codes for causing a computer to receive one or more customer modifications to the determined customer target budget allocation and storing the customer modified target budget allocation in the customer budget profile.

34. The computer program product 25, further comprising a sixth set of codes for causing a computer to determine peer target budget allocation data associated with the customer and provide the peer target budget allocation data to the customer.

35. The computer program product of claim 34, further comprising a seventh set of codes for causing a computer to receive customer selections for target budget allocation based on the peer target budget allocation data, wherein the customer selections are in lieu of receiving customer responses to the plurality of budget profile questions and determining the customer's target budget allocation for the plurality of budget categories based on the customer's responses to the plurality of budget profile questions.

36. The computer program of claim 34, wherein the sixth set of codes is further operable to cause the computer to determine the peer target budget allocation data, wherein the peer target budget allocation data includes at least one of life stage peer data, national statistical peer data or financial institution customers residing near the customer peer data.
